(19) United States
(12) Patent Application Publication
(10) Pub. No.: US 2025/0034379 A1
(43) Pub. Date: Jan. 30, 2025

(54) POLYPROPYLENE RESIN COMPOSITION AND MOLDED PRODUCT INCLUDING THE SAME

(71) Applicants: HYUNDAI MOTOR COMPANY, Seoul (KR); KIA CORPORATION, Seoul (KR); KOLON PLASTICS, INC., Gimcheon-si (KR)

(72) Inventors: Hyeong Won Park, Hwaseong-si (KR); Sun Ae Park, Seongnam-si (KR); Kyeong Jun Baek, Seongnam-si (KR); Seong-Won Seo, Gimcheon-si (KR)

(73) Assignees: HYUNDAI MOTOR COMPANY, Seoul (KR); KIA CORPORATION, Seoul (KR); KOLON PLASTICS, INC., Gimcheon-si (KR)

(21) Appl. No.: 18/529,398

(22) Filed: Dec. 5, 2023

(30) Foreign Application Priority Data
Jul. 28, 2023 (KR) 10-2023-0098593

(51) Int. Cl. C08L 23/12; B01D 39/16; C08K 5/00; C08K 7/14

(52) U.S. Cl. CPC C08L 23/12; B01D 39/1692; C08K 5/005; C08K 7/14; C08K 2201/003; C08K 2201/004; C08L 2201/08; C08L 2205/08; H01M 8/04044

(57) ABSTRACT

A polypropylene resin composition which may prevent deterioration of properties due to moisture. The polypropylene resin composition has low surface energy, and thus may increase chemical stability against external factors. Further, a molded product including the polypropylene resin composition may have low ion elution ability, which may be an important requirement, and may achieve high weight reduction.

### CROSS-REFERENCE TO RELATED APPLICATION

This application claims under 35 U.S.C. § 119 (a) the benefit of priority to Korean Patent Application No. 10-2023-0098593 filed on Jul. 28, 2023, the entire contents of which are incorporated herein by reference.

### BACKGROUND

### (a) Technical Field

The present disclosure relates to a polypropylene resin composition and a molded product including the same.

### (b) Description of the Related Art

In general, a fuel cell electric vehicle includes a fuel cell stack, an air supply device, and a thermal management system (TMS). The fuel cell stack generates electrical energy from hydrogen and oxygen as reaction gases, and discharges heat and water as byproducts. In order to prevent temperature rise of the fuel cell stack, a cooling device is essentially provided.

An ion filter serves to lower electrical conductivity of a coolant provided to the fuel cell stack to a designated level or less by filtering out ions included in the coolant. By removing the ions from the coolant, current leakage of the fuel cell stack through the coolant may be prevented, and consequently, electrical stability of the vehicle may be raised.

Ion filters mainly use a polyamide resin (PA66-GF55) at present, and it is expensive, and exhibits properties, which are continuously deteriorated, and elute ions, when it is exposed to a high-temperature coolant, and thus raises electrical conductivity of the coolant.

The above information disclosed in this Background section is only for enhancement of understanding of the background of the disclosure and therefore it may contain information that does not form the related art that is already known in this country to a person of ordinary skill in the art.

### SUMMARY OF THE DISCLOSURE

The present disclosure has been made in an effort to solve the above-described problems associated with the related art, and it is an object of the present disclosure to provide a polypropylene resin composition having stable properties.

An ion filter which is a molded product including the polypropylene resin composition has price competitiveness as well as chemical resistance, water resistance, and low ion elution ability.

In one aspect, the present disclosure provides a polypropylene resin composition including a polypropylene resin, a fibrous reinforcing agent, and a surface modifier.

In a preferred embodiment, an amount of the fibrous reinforcing agent may be 40 parts by weight to 55 parts by weight, based on 100 parts by weight of the polypropylene resin.

In another preferred embodiment, an amount of the surface modifier may be 0.1 parts by weight to 1 part by weight, based on 100 parts by weight of the polypropylene resin.

In still another preferred embodiment, a number average molecular weight (Mn) of the polypropylene resin may be 15,000 g/mol to 30,000 g/mol.

In yet another preferred embodiment, the polypropylene resin may include at least one selected from the group consisting of a polypropylene homopolymer and an ethylene-propylene copolymer.

In still yet another preferred embodiment, a melt index (MI) of the polypropylene resin may be 30 g/10 min to 50 g/10 min, as measured at a temperature of 230° C. under a load of 2.16 kg.

In a further preferred embodiment, the fibrous reinforcing agent may include at least one selected from the group consisting of glass fibers, carbon fibers, graphite fibers, metal fibers, basalt fibers, cotton fibers, wool fibers, silk fibers, aramid fibers, polyacrylonitrile (PAN) fibers, arylate fibers, polyether ether ketone (PEEK) fibers, nylon fibers, and polyethylene terephthalate (PET) fibers.

In another further preferred embodiment, a length of the fibrous reinforcing agent may be 6 mm to 25 mm.

In still another further preferred embodiment, a diameter of the fibrous reinforcing agent may be 12 μm to 20 μm.

In yet another further preferred embodiment, the surface modifier may include at least one selected from the group consisting of a silicon-based surface modifier, a wax-based surface modifier, and a stearate-based surface modifier.

In still yet another further preferred embodiment, the polypropylene resin composition may further include additives including at least one selected from the group consisting of a compatibilizer, a shock-resistant agent, and a heat-resistant agent.

In a still further preferred embodiment, the polypropylene resin composition may include the compatibilizer that may include at least one selected from a polypropylene homopolymer, an ethylene-propylene copolymer, and an ethylene-octene copolymer.

In a yet still further preferred embodiment, the polypropylene resin composition may include the compatibilizer that may be grafted with 0.8 wt % to 1.2 wt % of maleic anhydride, based on a total weight of the compatibilizer.

In another further preferred embodiment, the polypropylene resin composition may include the compatibilizer, where an amount of the compatibilizer may be 1 part by weight to 10 parts by weight, based on 100 parts by weight of the polypropylene resin.

In still another further preferred embodiment, the polypropylene resin composition may include the shock-resistant agent, where an amount of the shock-resistant agent may be 1 part by weight to 5 parts by weight, based on 100 parts by weight of the polypropylene resin.

In yet another further preferred embodiment, the polypropylene resin composition may include the heat-resistant agent that may include at least one selected from the group consisting of a phenol-based heat-resistant agent, and a phosphate-based heat-resistant agent.

In still yet another further preferred embodiment, the polypropylene resin composition may include the heat-resistant agent, where an amount of the heat-resistant agent may be 0.1 parts by weight to 1 part by weight, based on 100 parts by weight of the polypropylene resin.

In a still further preferred embodiment, the polypropylene resin composition may have a tensile strength of 125 MPa or higher based on ISO 527, a flexural strength of 170 MPa or higher based on ISO 178, an impact strength of 26 KJ/m² of higher based on ISO 180, and a heat deflection temperature of 158° C. or higher under a load of 1.8 MPa based on ISO 75.

In another aspect, the present disclosure provides a molded product including the polypropylene resin composition.

In a preferred embodiment, the molded product may further include an ion filter.

In another preferred embodiment, the molded product may have ion elution ability of 0.8 ppm or less.

Other aspects and preferred embodiments of the disclosure are discussed infra.

The above and other features of the disclosure are discussed infra.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

Recently, in order to solve eco-friendly issues, which are social issues, and to improve vehicle efficiency, the automotive industry is devoted to development in many ways. As a method to solve the eco-friendly issues, internal combustion engine vehicles, which were conventionally in the mainstream, are being replaced by electric vehicles and fuel cell electric vehicles (FCEVs). The FCEVs have a different driving method from the conventional internal combustion engine vehicles, and are thus equipped with new parts which were not conventionally used.

An ion filter, which is one of parts of the FCEVs, is a core part serving to remove eluted ions used in the FCEVs from a coolant. The ion filter is a consumable, and thus, the exchange cycle of the ion filter gets faster (shortens) as the amount of the ions eluted in the coolant increases, and thereby, the replacement cycle of the ion filter may get faster and cost taken to replace the ion filter may be increased. Therefore, it is important to reduce of the amount of the ions, which will be eluted in the coolant, in advance in terms of marketability and cost, and thus, not only materials applied to a thermal management system (TMS) but also all parts being in direct contact with the coolant should have low ion elution ability.

However, materials which are used in ion filters at present are not enough to satisfy the low ion elution ability. Parts of an internal combustion engine vehicle, which come into contact with an antifreeze, do not have the high important of ion elution, but all parts of a fuel cell electric vehicle should have minimized ion elution ability and thus it is difficult to solve such an ion elution problem using the conventionally used materials.

A metallic material, such as steel or aluminum alone, was conventionally used, but such a material causes the risk of latent corrosion, and further causes ion elution in the event of corrosion.

Further, a polyamide resin PA66-GF55 which is being applied at present, includes 30-40 wt % of short glass fibers having a length of 2-3 mm and may thus have high thermal stability, but has drawbacks in which properties of a product are deteriorated when the product is exposed to water, due to the nature of polyamide 66 (PA66), and high flowability required for optimization of productivity in an injection mold is not obtained because PA66 having a low relative viscosity, which is a modified polyamide resin, is used.

That is, the corresponding part of the conventional internal combustion engine vehicle used the modified polyamide resin having high thermal stability because the temperature of a cooling fluid is very high due to heat generated from an internal combustion engine. However, in the case of the fuel cell electric vehicle, the temperature of generated heat is relatively low, a degree of rise in the temperature of a cooling fluid is relatively low thereby, and a temperature environment to which a general polypropylene resin may be applied is created. Moreover, when the polypropylene resin is used, the corresponding product has properties less deteriorated due to moisture and low surface energy, and may thus increase chemical stability against external factors. Further, the corresponding product may have low ion elution ability, which is the most important requirement, and may achieve high weight reduction.

A polypropylene resin composition according to the present disclosure may include a polypropylene resin, a fibrous reinforcing agent, and a surface modifier.

Hereinafter, the respective components of the polypropylene resin composition will be described in detail.

### (A) Polypropylene Resin

The polypropylene resin according to the present disclosure may indicate a thermoplastic resin including an aliphatic molecular chain.

The number average molecular weight (Mn) of the polypropylene resin may be 15,000 g/mol to 30,000 g/mol.

The polypropylene resin may include at least one selected from the group consisting of a polypropylene homopolymer, an ethylene-propylene copolymer, and a combination thereof.

The melt index (MI) of the polypropylene resin, measured at a temperature of 230° C. under a load of 2.16 kg, may be 30 g/10 min to 50 g/10 min. When the MI of the polypropylene resin is less than 30 g/10 min, the polypropylene resin may exhibit poor impregnability in the fibrous reinforcing agent and poor mechanical properties due to low flowability due to the nature of manufacture of long fiber reinforced thermoplastic (LFT), and, when the MI of the polypropylene resin exceeds 50 g/10 min, the polypropylene resin may exhibit poor mechanical properties caused by deterioration in the properties of the polypropylene resin itself due to the low molecular weight thereof.

### (B) Fibrous Reinforcing Agent

The fibrous reinforcing agent according to the present disclosure may include at least one selected from the group consisting of glass fibers, carbon fibers, graphite fibers, metal fibers, basalt fibers, cotton fibers, wool fibers, silk fibers, aramid fibers, polyacrylonitrile (PAN) fibers, arylate fibers, polyether ether ketone (PEEK) fibers, nylon fibers, polyethylene terephthalate (PET) fibers, and combinations thereof, and preferably, the fibrous reinforcing agent may be glass fibers.

The length of the fibrous reinforcing agent may be 6 mm to 25 mm, and for example, 7 mm to 20 mm, 8 mm to 18 mm, or 9 mm to 15 mm

As a material which is used as an ion filter housing at present, a material including a polyamide resin and 35 wt % of short fibrous reinforcing agent (glass fibers) having a length of 2-3 mm is used. However, the above material is expensive and, when the material is exposed to a high-temperature coolant, the properties of the material are continuously deteriorated, the material elutes ions in the coolant, and thus, the electrical conductivity of the coolant is raised. In the present disclosure, in order to solve these problems, a material including the polypropylene resin and 30-70 wt % of long fibrous reinforcing agent (glass fibers) having a length of 6-25 mm is applied so as to sufficiently perform its role based on stable properties thereof under an alleviated usage environment and to achieve weight reduction as well as chemical resistance, water resistance, and low ion elution ability due to change in the polymer resin.

The diameter of the fibrous reinforcing agent may be 12 μm to 20 μm.

The amount of the fibrous reinforcing agent may be 40 parts by weight to 55 parts by weight, preferably, 42.15 parts by weight to 51.52 parts by weight, based on 100 parts by weight of the polypropylene resin. When the amount of the fibrous reinforcing agent is less than 40 parts by weight, tensile strength and flexural strength of the polypropylene resin composition may be reduced, and, when the amount of the fibrous reinforcing agent exceeds 55 parts by weight, injection moldability of the polypropylene resin composition may be reduced due to a surface defect or reduced flowability in molding.

The fibrous reinforcing agent may be glass fibers, and the glass fibers may be provided in an E-glass roving type in which infinitely long glass fiber is wound. Preferably, the surfaces of the glass fibers may be coupled with silane so as to achieve interfacial adhesion with a final composition.

### (C) Surface Modifier

The surface modifier according to the present disclosure serves to enhance flowability so as to improve surface quality of an injection molded product including the polypropylene resin composition.

The surface modifier may include at least one selected from the group consisting of a silicon-based surface modifier, a wax-based surface modifier, a stearate-based surface modifier, and combinations thereof, and may be, for example, a silicon-based surface modifier.

The amount of the surface modifier may be 0.1 parts by weight to 1 part by weight, preferably, 0.44 parts by weight to 0.66 parts by weight, based on 100 parts by weight of the polypropylene resin. When the amount of the surface modifier is less than 0.1 parts by weight, the surface modifier may have difficulty in exhibiting a function of modifying the surface quality of the injection molded product including the polypropylene resin composition, and, when the amount of the surface modifier exceeds 1 part by weight, the surface modifier may act as an impurity and thus reduce mechanical properties of the polypropylene resin composition.

### (D) Additives

The polypropylene resin composition according to the present disclosure may further include additives including at least one selected from the group consisting of a compatibilizer, a shock-resistant agent, a heat-resistant agent, and combinations thereof.

The compatibilizer serves to improve compatibility between the polypropylene resin and the fibrous reinforcing agent.

The compatibilizer may include at least one selected from a polypropylene homopolymer, an ethylene-propylene copolymer, an ethylene-octene copolymer, and combinations thereof.

The compatibilizer may be grafted with 0.8 wt % to 1.2 wt % of maleic anhydride, based on 100 wt % of the compatibilizer.

The amount of the compatibilizer may be 1 part by weight to 10 parts by weight, preferably, 3.93 parts by weight to 5.90 parts by weight, based on 100 parts by weight of the polypropylene resin. When the amount of the compatibilizer is less than 1 part by weight, the mechanical properties of the product may be less desirable due to difficulty in raising compatibility between the polypropylene resin and the fibrous reinforcing agent, and, when the amount of the compatibilizer exceeds 10 parts by weight, the excess of the compatibilizer is present as an unreacted material and thus the mechanical properties of the product may also be less desirable.

The shock-resistant agent serves to improve impact performance of the polypropylene resin composition.

The amount of the shock-resistant agent may be 1 part by weight to 5 parts by weight, preferably, 2.62 parts by weight to 3.93 parts by weight, based on 100 parts by weight of the polypropylene resin. When the amount of the shock-resistant agent is less than 1 part by weight, overall distribution of the shock-resistant agent may be poor and thus it may be difficult to improve the impact performance of the polypropylene resin composition, and, when the amount of the shock-resistant agent exceeds 5 parts by weight, the impact performance of the polypropylene resin composition may be improved but the tensile strength, flexural strength and other mechanical properties of the polypropylene resin composition may be reduced.

The heat-resistant agent serves to improve heat resistance of the polypropylene resin composition.

The heat-resistant agent may include at least one selected from the group consisting of a phenol-based heat-resistant agent, a phosphate-based heat-resistant agent, and a combination thereof.

The amount of the heat-resistant agent may be 0.1 parts by weight to 1 part by weight, preferably, 0.44 parts by weight to 0.66 parts by weight, based on 100 parts by weight of the polypropylene resin. When the amount of the heat-resistant agent is less than 0.1 parts by weight, the heat-resistant agent may not exhibit the effect of improving heat resistance of the polypropylene resin composition, and, when the amount of the heat-resistant agent exceeds 1 part by weight, the effect of improving heat resistance of the polypropylene resin composition may be insignificant and thus the heat-resistant agent may be economically infeasible.

Further, an antioxidant, a flame retardant, a fluorescent whitening agent, a plasticizer, a thickener, an anti-static agent, a release agent, a pigment, a nucleating agent, or combinations thereof may be added to the polypropylene resin composition within a range which does not infringe the objects of the present disclosure.

When the polypropylene resin composition is manufactured, a melt-kneading method and apparatus, which are generally used, may be used. As a concrete example of the apparatus used in melt-kneading, there is a single or twin screw extruder. When the single or twin screw extruder is used to perform uniform kneading of raw materials, the polypropylene resin and the heat-resistant agent may be fed into an inlet so as to achieve the uniform kneading effect by the shear force of the screw(s) in the extruder. In order to reduce volatilization of the additives and to maximize the properties of the composition in melt-kneading, the retention time of the raw materials in the apparatus, such as the extruder, may be minimized.

The polypropylene resin composition may be manufactured by melt-kneading the polypropylene resin, the heat-resistant agent, and the fibrous reinforcing agent, i.e., glass fibers, at a temperature of 230° C. to 300° C. When the melt-kneading temperature is lower than 230° C., the melt-kneading temperature is higher than the melting point of the polypropylene resin but the polypropylene resin may exhibit sufficient impregnability due to low flowability thereof, and, when the melt-kneading temperature is higher than 300° C., quality of the polypropylene resin composition may be deteriorated due to pyrolysis or volatilization of the additives or the polypropylene resin.

Further, in order to improve stiffness of the polypropylene resin composition, the glass fibers serving as the fibrous reinforcing agent are not fed into the same extruder, but are fed into an impregnation die while being continuously unwound from a separate rack, and an impregnation process, in which the fed polypropylene resin and heat-resistant agent fill gaps between filaments of glass fiber bundles in the impregnation die, is performed.

The polypropylene resin composition according to the present disclosure may have tensile strength of 125 MPa or higher based on ISO 527, flexural strength of 170 MPa or higher based on ISO 178, impact strength of 26 KJ/m² or higher based on ISO 180, and a heat deflection temperature of 158° C. or higher under a load of 1.8 MPa based on ISO 75.

In another aspect, the present disclosure relates to a molded product including the above-described polypropylene resin composition.

The molded product may be applied to ion filters, and the application fields of the molded product are not limited.

An ion filter including the polypropylene resin composition according to the present disclosure is characterized in that the ion filter exhibits excellent chemical resistance and water resistance and low ion elution ability based on stable properties of the polypropylene resin composition under an alleviated usage environment, and achieves weight reduction.

The ion elution ability of the molded product may be equal to or less than 0.8 ppm.

Hereinafter, the present disclosure will be described in more detail through the following Examples and Comparative Examples. The following Examples and Comparative Examples serve merely to exemplarily describe the present disclosure, and are not intended to limit the scope and spirit of the invention.

### Examples 1-3 and Comparative Examples 2-17

4.92 parts by weight of a compatibilizer (NB1620 produced by Woosung Chemical Co., Ltd.), 3.28 parts by weight of a shock-resistant agent (Engage 8200 produced by Dow Chemical Company), 0.55 parts by weight of a heat-resistant agent (Songnox 1010 produced by SONGWON Industrial Co., Ltd.), and respective amounts, which are set forth in Table 1, of corresponding surface modifiers, based on 100 parts by weight of a polypropylene resin (HP480S produced by PolyMirae Co., Ltd.) were added to the polypropylene resin, and were mixed using a twin screw kneader (TEX-44) having a diameter of 44 mm. Respective polypropylene resin pellets having a length of 10 mm were manufactured by impregnating respective amounts, which are set forth in Table 1, of glass fibers (SE4121 having a diameter 15-20 μm and a length of 10-12 mm produced by Owens Corning) supplied from a roving, serving as a fibrous reinforcing agent, with the respective prepared mixtures.

### Comparative Example 1

Polypropylene resin pellets were manufactured using the same method as in Example 1 except that no surface modifier was added.

### Comparative Example 18

Polypropylene resin pellets were manufactured using the same method as in Example 1 except that a polyamide resin, i.e., polyamide 66 (PA66), and short (chopped) glass fibers having a diameter 15-20 μm and a length of 2-5 mm serving as a fibrous reinforcing agent were used instead of the polypropylene resin and the glass fibers (SE4121 mm having a diameter 15-20 μm produced by Owens Corning) used in Example 1.

### Comparative Examples 19 to 21

Polypropylene resin pellets were manufactured using the same method as in Example 1 except that short (chopped) glass fibers having a diameter 15-20 μm and a length of 2-5 mm were used as a fibrous reinforcing agent.

TABLE 1

| Unit: | | Fibrous | | Shock- | Heat- | | | |
|---|---|---|---|---|---|---|---|---|
| Part by | | reinforcing | Compati- | resistant | resistant | Surface modifier | | |
| weight | PP | agent | bilizer | agent | agent | (A) | (B) | (C) |
| Example 1 | 100 | 46.84 | 4.92 | 3.28 | 0.55 | 0.44 | | |
| Example 2 | 100 | 46.84 | 4.92 | 3.28 | 0.55 | 0.55 | | |
| Example 3 | 100 | 46.84 | 4.92 | 3.28 | 0.55 | 0.66 | | |
| Comp. | 100 | 46.84 | 4.92 | 3.28 | 0.55 | | | |
| Example 1 | | | | | | | | |
| Comp. | 100 | 46.84 | 4.92 | 3.28 | 0.55 | | 0.55 | |
| Example 2 | | | | | | | | |
| Comp. | 100 | 46.84 | 4.92 | 3.28 | 0.55 | | | 0.55 |
| Example 3 | | | | | | | | |
| Comp. | 100 | 46.84 | 4.92 | 3.28 | 0.55 | 0.2 | | |
| Example 4 | | | | | | | | |
| Comp. | 100 | 46.84 | 4.92 | 3.28 | 0.55 | 0.9 | | |
| Example 5 | | | | | | | | |
| Comp. | 100 | 109.29 | 4.92 | 3.28 | 0.55 | 0.44 | | |
| Example 6 | | | | | | | | |
| Comp. | 100 | 109.29 | 4.92 | 3.28 | 0.55 | 0.55 | | |
| Example 7 | | | | | | | | |
| Comp. | 100 | 109.29 | 4.92 | 3.28 | 0.55 | 0.66 | | |
| Example 8 | | | | | | | | |
| Comp. | 100 | 27.32 | 4.92 | 3.28 | 0.55 | 0.44 | | |
| Example 9 | | | | | | | | |
| Comp. | 100 | 27.32 | 4.92 | 3.28 | 0.55 | 0.55 | | |
| Example 10 | | | | | | | | |
| Comp. | 100 | 27.32 | 4.92 | 3.28 | 0.55 | 0.66 | | |
| Example 11 | | | | | | | | |
| Comp. | 100 | 72.86 | 4.92 | 3.28 | 0.55 | 0.44 | | |
| Example 12 | | | | | | | | |
| Comp. | 100 | 72.86 | 4.92 | 3.28 | 0.55 | 0.55 | | |
| Example 13 | | | | | | | | |
| Comp. | 100 | 72.86 | 4.92 | 3.28 | 0.55 | 0.66 | | |
| Example 14 | | | | | | | | |
| Comp. | 100 | 163.93 | 4.92 | 3.28 | 0.55 | 0.44 | | |
| Example 15 | | | | | | | | |
| Comp. | 100 | 163.93 | 4.92 | 3.28 | 0.55 | 0.55 | | |
| Example 16 | | | | | | | | |
| Comp. | 100 | 163.93 | 4.92 | 3.28 | 0.55 | 0.66 | | |
| Example 17 | | | | | | | | |
| Comp. | 100 | 42.86 | 4.92 | 3.28 | 0.55 | 0.44 | | |
| Example 19 | | | | | | | | |
| Comp. | 100 | 66.67 | 4.92 | 3.28 | 0.55 | 0.44 | | |
| Example 20 | | | | | | | | |
| Comp. | 100 | 100 | 4.92 | 3.28 | 0.55 | 0.44 | | |
| Example 21 | | | | | | | | |

(A): 250H (produced by Sunil Corp.)
(B): PE-Wax (produced by Plastic Service Corp.)
(C): Calcium-Stearate (Sinwon Chemical Co., Ltd.)

TABLE 2

| Unit: | | Fibrous | | Shock- | Heat- | | | |
|---|---|---|---|---|---|---|---|---|
| parts by | PA | reinforcing | Compati- | resistant | resistant | Surface modifier | | |
| weight | 66 | agent | bilizer | agent | agent | (A) | (B) | (C) |

| | | | | | | |
|---|---|---|---|---|---|---|
| Comp. | 100 | 53.85 | 4.92 | 3.28 | 0.55 | 0.44 |
| Example | | | | | | |
| 18 | | | | | | |

PA66(Polyamide 66): Lanxess Corp.

### Test Example 1: Comparison Between Examples and Comparative Examples

The manufactured pellets according to Examples 1-3 and Comparative Examples 1-21 were made into specimens using an injection molding machine having clamping force of 170 tons so as to meet ISO standards, and flowability of the resin, and tensile strength, flexural strength, flexural modulus, and impact strength of each of the specimens were measured. Results of measurement are set forth in Table 3.
Setting of resin temperature: 260° C. (260, 255, 250, 245, 245, and 240° C.)
Setting of mold temperature: 80° C.
Holding pressure: 50 MPa
Holding time: 5 seconds
Cooling time: 15 seconds
Tensile strength: measured by a method based on ISO 527
Flexural strength: measured by a method based on ISO 178
Flexural modulus: measured by a method based on ISO 178
Impact strength: measured by a method based on ISO 180
Heat deflection temperature: measured by a method based on ISO 75
Specific gravity: measured by a method based on ISO 1183-1

TABLE 3

| | Tensile | Flexural | Impact | | |
|---|---|---|---|---|---|
| | strength | strength | strength | Heat deflection | Specific |
| Category | (MPa) | (MPa) | (kJ/m²) | temp. (° C.) | gravity |
| Example 1 | 125 | 170 | 26.1 | 159 | 1.10 |
| Example 2 | 128 | 172 | 27.4 | 160 | 1.10 |
| Example 3 | 127 | 174 | 26.2 | 159 | 1.10 |
| Comp. | 120 | 165 | 25.8 | 159 | 1.10 |
| Example 1 | | | | | |
| Comp. | 108 | 145 | 17.6 | 157 | 1.10 |
| Example 2 | | | | | |
| Comp. | 111 | 142 | 19.5 | 157 | 1.10 |
| Example 3 | | | | | |
| Comp. | 120 | 164 | 24.8 | 159 | 1.10 |
| Example 4 | | | | | |
| Comp. | 110 | 148 | 19.4 | 158 | 1.10 |
| Example 5 | | | | | |
| Comp. | 145 | 206 | 27 | 160 | 1.29 |
| Example 6 | | | | | |
| Comp. | 149 | 210 | 28 | 160 | 1.29 |
| Example 7 | | | | | |
| Comp. | 146 | 207 | 28 | 159 | 1.29 |
| Example 8 | | | | | |
| Comp. | 110 | 135 | 16.8 | 157 | 1.02 |
| Example 9 | | | | | |
| Comp. | 113 | 138 | 17.3 | 157 | 1.02 |
| Example 10 | | | | | |
| Comp. | 112 | 138 | 18.4 | 157 | 1.02 |
| Example 11 | | | | | |
| Comp. | 135 | 190 | 26.4 | 160 | 1.18 |
| Example 12 | | | | | |
| Comp. | 138 | 184 | 27.1 | 160 | 1.18 |
| Example 13 | | | | | |
| Comp. | 132 | 194 | 26.9 | 160 | 1.18 |
| Example 14 | | | | | |
| Comp. | 155 | 210 | 24.5 | 161 | 1.42 |
| Example 15 | | | | | |
| Comp. | 159 | 208 | 26.4 | 161 | 1.42 |
| Example 16 | | | | | |
| Comp. | 162 | 215 | 24.8 | 161 | 1.42 |
| Example 17 | | | | | |
| Comp. | 190 | 300 | 12 | 250 | 1.41 |
| Example 18 | | | | | |
| Comp. | 105 | 140 | 10 | 155 | 1.12 |
| Example 19 | | | | | |
| Comp. | 114 | 161 | 11 | 155 | 1.2 |
| Example 20 | | | | | |
| Comp. | 134 | 185 | 12 | 157 | 1.31 |
| Example 21 | | | | | |

Referring to the above results, it may be confirmed that, as the amount of the surface modifier increases (in Examples 1 to 3 compared to Comparative Example 1), the flowability of the resin is improved, it is easy to impregnate the filaments in the glass fiber bundles with the resin, and thereby, the mechanical properties of the specimen including the polypropylene resin composition are improved.

Further, it may be confirmed that, when no surface modifier is added, as in Comparative Example 1, the flowability of the resin is low, impregnability of the filaments in the glass fiber bundles with the resin is reduced, and thereby, the mechanical properties of the corresponding specimen including the polypropylene resin composition are not excellent. It may be confirmed that, when the amount of the surface modifier is excessively low or high, as in Comparative Example 4 or 5, the mechanical strength of the specimen including the polypropylene resin composition is remarkably reduced.

It may be confirmed that, in the case of Comparative Example 18 in which the conventional material, i.e., polyamide 66 (PA66), is used, the specific gravity of the specimen including the polypropylene resin composition is somewhat great. Therefore, when the polypropylene resin is applied instead of polyamide 66 (PA66), as in the present disclosure, a weight reduction effect may be expected.

Through comparison between Examples 1-3 and Comparative Examples 1-5, it may be conformed that, when the fibrous reinforcing agent is used in the same amount, the specific gravities of the specimens including the corresponding polypropylene resin compositions are similar, but the tensile strengths, the flexural strengths, and the impact strengths of the specimens according to Examples 1-3 are high compared to the specimens according to Comparative Examples 1-5, and therefore, a part having stronger mechanical properties may be manufactured using the polypropylene resin composition according to the present disclosure without increasing the weight of the part.

Furthermore, the surface modifier is not limited to a specific kind, but it may be confirmed that the properties of the specimens including the polypropylene resin compositions using a silicon-based surface modifier according to Examples 1-3 are a little greater than those of the specimen including the polypropylene resin composition using a wax-based surface modifier according to Comparative Example 2 and the specimen including the polypropylene resin composition using a stearate-based surface modifier according to Comparative Example 3.

### Test Example 2: Comparison of Tensile Strength Depending on Temperature of Coolant

The manufactured pellets according to Example 2 and Comparative Example 18 were made into respective specimens using the injection molding machine having clamping force of 170 tons, and the tensile strengths of the respective specimens depending on the temperature of a coolant were measured. Results of measurement are set forth in Table 4 below.

TABLE 4

| | Tensile | | | | | |
|---|---|---|---|---|---|---|
| | strength | | | | | |
| Category | (MPa) | 250 hr | 500 hr | 1000 hr | 2000 hr | 3000 hr |
| | | Tensile strength (MPa) after aging in coolant at 100° C. | | | | |
| Example 2 | 125 | 117 | 117 | 115 | 114 | 110 |
| Comp. | 190 | 92 | 88 | 90 | — | — |
| Example 18 | | | | | | |
| | | Tensile strength (MPa) after aging in coolant at 110° C. | | | | |
| Example 2 | 125 | 115 | 114 | 112 | 109 | 106 |
| Comp. | 190 | 80 | 81 | 85 | — | — |
| Example 18 | | | | | | |
| | | Tensile strength (MPa) after aging in coolant at 120° C. | | | | |
| Example 2 | 125 | 109 | 113 | 114 | 115 | 116 |
| Comp. | 190 | 70 | 70 | 70 | — | — |
| Example 18 | | | | | | |

Referring to this table, the mechanical properties of the specimen according to Comparative Example 18 were continuously reduced depending on aging in the coolant, but deterioration in the mechanical properties of the specimen according to Example 2 was insignificantly slight even when the corresponding specimen was exposed to the coolant.

An ion filter housing, which is a target part of the present disclosure, is characterized in that it is exposed to a coolant at all times. Through the above results, it may be confirmed that the specimen according to Example 2 has an advanced effect of being used as a vehicle part which is usable for a long time compared to the conventional composition, i.e., the specimen according to Example 18, and may thus supplement insufficient mechanical properties at the initial stage.

That is, the specimen according to Example 2, which includes the polypropylene resin and the surface modifier, has high surface quality compared to the specimen according to Example 18, which includes PA66 and does not include any surface modifier, and may minimize pores between the fibrous reinforcing agent and the resin, exposed in the surface of the specimen under a high-temperature antifreeze environment. Moreover, deterioration in the properties of the surface layer of a fiber glass-reinforced injection molded product caused by absorption of water from the pores may be prevented. That is, it may be confirmed that addition of the surface modifier may exhibit the effect of preventing deterioration in the properties of a molded product including the polypropylene resin composition under the high-temperature antifreeze environment.

Further, the polypropylene resin minimizes chemical reaction with the coolant (50 wt % of an antifreeze+50 wt % of water) due to the molecular structure thereof, and thus, even when the polypropylene resin is exposed to the high-temperature coolant for a long time, deterioration in the mechanical properties of the polypropylene resin is extremely limited. On the contrary, PA66 is hydrolyzed in the high-temperature coolant due to characteristics of amide-based materials and thus the mechanical properties of PA66 are continuously deteriorated. Therefore, it may be confirmed that the polypropylene resin is advantageous under the high-temperature coolant environment compared to PA66.

### Test Example 3: Comparison of Ion Elution Ability

Molded products (ion filters) including the compositions according to Example 2 and Comparative Example 18 were manufactured, and ion elution abilities of the molded products were measured. Results of measurement are set forth in Table 5 below.
Measurement method: measured using MS211-80 (ion elution evaluation method) and ICP-AES (inductively coupled plasma atomic emission spectroscopy)

TABLE 5
Ion elution (ppm)

| DI-water (reference) | Example 2 | Comp. Example 18 |
|---|---|---|
| 0.4 | 0.8 | 14.6 |

It may be confirmed that the molded product according to Example 2 has a low processing temperature compared to the molded product using PA66 according to Example 18, and improves ion elution ability compared to the molded product including the conventional composition, because an environmental temperature is lowered due to change from an internal combustion engine vehicle environment to a fuel cell electric vehicle environment, less heat resistance performance is required, and thus, an antioxidant and a heat-resistant stabilizer including metallic ions may be excluded.

As is apparent from the above description, a polypropylene resin composition according to the present disclosure may prevent deterioration in properties due to moisture and may have low surface energy, thereby being capable of increasing chemical stability against external factors. Further, a molded product including the polypropylene resin composition may have low ion elution ability, which is the most important requirement, and may achieve high weight reduction.

The disclosure has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polypropylene resin composition comprising:
a polypropylene resin;
a fibrous reinforcing agent; and
a surface modifier.

2. The polypropylene resin composition of claim 1, wherein an amount of the fibrous reinforcing agent is 40 parts by weight to 55 parts by weight, based on 100 parts by weight of the polypropylene resin.

3. The polypropylene resin composition of claim 1, wherein an amount of the surface modifier is 0.1 parts by weight to 1 part by weight, based on 100 parts by weight of the polypropylene resin.

4. The polypropylene resin composition of claim 1, wherein a number average molecular weight (Mn) of the polypropylene resin is 15,000 g/mol to 30,000 g/mol.

5. The polypropylene resin composition of claim 1, wherein the polypropylene resin comprises at least one selected from the group consisting of a polypropylene homopolymer and an ethylene-propylene copolymer.

6. The polypropylene resin composition of claim 1, wherein a melt index (MI) of the polypropylene resin is 30 g/10 min to 50 g/10 min, as measured at a temperature of 230° C. under a load of 2.16 kg.

7. The polypropylene resin composition of claim 1, wherein the fibrous reinforcing agent comprises at least one selected from the group consisting of glass fibers, carbon fibers, graphite fibers, metal fibers, basalt fibers, cotton fibers, wool fibers, silk fibers, aramid fibers, polyacrylonitrile (PAN) fibers, arylate fibers, polyether ether ketone (PEEK) fibers, nylon fibers, and polyethylene terephthalate (PET) fibers.

8. The polypropylene resin composition of claim 1, wherein a length of the fibrous reinforcing agent is 6 mm to 25 mm.

9. The polypropylene resin composition of claim 1, wherein a diameter of the fibrous reinforcing agent is 12 μm to 20 μm.

10. The polypropylene resin composition of claim 1, wherein the surface modifier comprises at least one selected from the group consisting of a silicon-based surface modifier, a wax-based surface modifier, and a stearate-based surface modifier.

11. The polypropylene resin composition of claim 1, further comprising additives comprising at least one selected from the group consisting of a compatibilizer, a shock-resistant agent, and a heat-resistant agent.

12. The polypropylene resin composition of claim 11, comprising the compatibilizer that comprises at least one selected from a polypropylene homopolymer, an ethylene-propylene copolymer, and an ethylene-octene copolymer.

13. The polypropylene resin composition of claim 11, comprising the compatibilizer that is grafted with 0.8 wt % to 1.2 wt % of maleic anhydride, based on a total weight of the compatibilizer.

14. The polypropylene resin composition of claim 11, comprising the compatibilizer, wherein an amount of the compatibilizer is 1 part by weight to 10 parts by weight, based on 100 parts by weight of the polypropylene resin.

15. The polypropylene resin composition of claim 11, comprising the shock-resistant agent, wherein an amount of the shock-resistant agent is 1 part by weight to 5 parts by weight, based on 100 parts by weight of the polypropylene resin.

16. The polypropylene resin composition of claim 11, comprising the heat-resistant agent that comprises at least one selected from the group consisting of a phenol-based heat-resistant agent, and a phosphate-based heat-resistant agent.

17. The polypropylene resin composition of claim 11, comprising the heat-resistant agent, wherein an amount of the heat-resistant agent is 0.1 parts by weight to 1 part by weight, based on 100 parts by weight of the polypropylene resin.

18. The polypropylene resin composition of claim 1, wherein the polypropylene resin composition has:
a tensile strength of 125 MPa or higher based on ISO 527;
a flexural strength of 170 MPa or higher based on ISO 178;
an impact strength of 26 KJ/m² of higher based on ISO 180; and
a heat deflection temperature of 158° C. or higher under a load of 1.8 MPa based on ISO 75.

19. A molded product comprising the polypropylene resin composition of claim 1.

20. The molded product of claim 19, further comprising an ion filter.

21. The molded product of claim 19, wherein the molded product has ion elution ability of 0.8 ppm or less.
